(19) United States
(12) Patent Application Publication
(10) Pub. No.: US 2004/0213303 A1
(43) Pub. Date: Oct. 28, 2004

(54) Optical frequency synthesizer

(75) Inventor: Kerry I. Litvin, Huntingdon Valley, PA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: General Instrument Corporation

(21) Appl. No.: 10/420,143

(22) Filed: Apr. 22, 2003

(51) Int. Cl. H01S 3/10

(52) U.S. Cl. 372/28

(57) ABSTRACT

An optical frequency synthesizer controls a tunable laser to output signals having specific wavelengths. The synthesizer includes a wavelength discriminating device, a wavelength tuning device and a phase locked loop (PLL) circuit. The wavelength discriminating device receives a sample of the signals outputted by the tunable laser, processes the sample signals and passes the processed sample signals to the PLL circuit. Based on the processed sample signals, the PLL circuit controls the wavelength tuning device to tune the laser to output the signals having specific wavelengths.

### BACKGROUND OF THE INVENTION

1. Field of the Invention

The present invention generally relates to controlling the wavelength of an optical gain medium used in a tunable laser or other optical device that outputs signals having specific wavelengths.

2. Background Information

FIG. 1 shows a basic radio frequency (RF) synthesizer 100 with a feedback control loop configuration including a stable fixed frequency oscillator 105 operating at a reference frequency that is lower than the output frequencies to be synthesized. The oscillator 105 is, in most cases, derived from a piezo-electric crystal oscillator operating at a few MHz. The feedback control loop also includes a voltage controlled oscillator (VCO) 110 that generates the output signal at the desired frequency. The VCO 110 is tunable with the application of a control voltage. In the simplest designs, the output frequency of the VCO 110 is an exact integer multiple of the frequency outputted by the oscillator 105. In order to provide a feedback control mechanism, a portion of the VCO signal is tapped off for comparison to the reference oscillator frequency. To accomplish this comparison, the sampled VCO signal is first sent to a frequency divider 115. The purpose of the frequency divider 115 is to divide the frequency of the VCO 110 by some preset integer, N, that is the intended multiple of the frequency of the oscillator 105. If the VCO frequency is N times the reference oscillator frequency, then the output frequency of the frequency divider is the same as the reference oscillator frequency. If the VCO frequency is not exactly N times the reference frequency, the output frequency of the frequency divider is either greater than or less than the reference oscillator frequency. A phase-frequency detector 120 is used to make the comparison between the reference oscillator frequency and frequency divider output frequency. The reference oscillator signal is fed into the detector 120 along with the output of the frequency divider 115. The comparison between the frequencies of the two signals is made and an error signal 125 is produced. If the two frequencies are identical, then the error signal is zero. If the VCO frequency is high, the error signal has a positive polarity and its magnitude depends on the error magnitude. Similarly, if the VCO frequency is low, the error signal has a negative polarity and its magnitude depends on the error magnitude. The error signal is used to control the VCO frequency and drive the error to zero at which point the VCO frequency would be exactly N times the reference frequency. Typically, the error signal emanating from the phase-frequency detector is rapidly changing and rather noisy. Thus, before it can be applied to the VCO's frequency control terminals it must first be filtered. The final element in the basic PLL frequency synthesizer is an active op-amp based low pass filter 130. The low pass filter 130 conditions the raw error signal so that it is suitable for application to the VCO. The output of the filter is applied to the VCO's frequency control terminals. This feedback control loop, when set-up properly, drives the error to zero and thus locks the VCO frequency to exactly N times the reference frequency value.

The great utility of the PLL comes about because the frequency divider value, N, is not a fixed value and may be set to any value within a given range Nₘᵢₙ<N<Nₘₐₓ. This frequency divider ratio is digitally programmable and may be changed rapidly with a microprocessor control unit. For an appropriately chosen VCO, the range of frequencies which can be synthesized is thus f_{ref}×Nₘᵢₙ≦fₒᵤₜ_{≦f}_{ref}×Nₘₐₓ, where fₒᵤₜ is the VCO (RF frequency synthesizer) output frequency and f_{ref} is the fixed reference oscillator frequency. The minimum output frequency step size for this basic design is simply the reference frequency (f_{ref}). Furthermore, to be useful, the VCO must be single valued. That is, for every desired output frequency, within its specified operating range, there is only one control voltage value that produces a given VCO frequency.

Modern frequency synthesizer IC's contain the phase-frequency detector, programmable frequency dividers, and several other adjustable control mechanisms to assist in optimizing a given design such as the ability to search and lock onto the desired frequency. The fixed reference oscillator, VCO, and active low pass filter are typically external to the PLL chip. The desired frequencies to be synthesized at the VCO output often exceed the bandwidth of the onboard frequency dividers provided by the PLL chip. In this case, a fixed value high-frequency divider is used ahead of programmable on-board dividers of the PLL. This fixed frequency divider is usually referred to as a frequency prescaler and typically has a set value of 2ⁿ (16, 32, 64, 128 . . . etc.).

FIG. 2 is a block diagram of a conventional RF PLL frequency synthesizer, which has a response described by the following equation:

$$\frac{{θ}_{OUT}}{{θ}_{REF}} = \frac{{K}_{θ} \cdot \frac{{K}_{v}}{s} \cdot \frac{1}{M \cdot N + A} \cdot H ( s )}{1 + {K}_{0} \cdot \frac{{K}_{v}}{s} \cdot \frac{1}{M \cdot N + A} \cdot H ( s )} \qquad ( 1 )$$

### SUMMARY OF THE INVENTION

In a preferred embodiment, an optical frequency synthesizer is modified such that it may be used to control a tunable laser to output signals having specific wavelengths. The synthesizer includes a wavelength discriminating filter, a tunable optical filter in communication with the laser, and a phase locked loop (PLL) circuit in communication with the wavelength discriminating filter and the tunable optical filter. The wavelength discriminating filter receives a sample of the signals outputted by the tunable laser, filters the sample signals, and outputs the filtered sample signals. Based on the filtered sample signals received from the wavelength discriminating filter, the PLL circuit controls the tunable optical filter to tune the laser to output the signals having specific wavelengths.

The PLL circuit may include a photodiode in communication with the wavelength discriminating filter, and an amplifier in communication with the photodiode. The photodiode and amplifier are used to convert optical signals received from the wavelength discriminating filter into electrical signals.

The PLL circuit may further include a first active low pass loop filter in communication with the amplifier, and a voltage controlled oscillator (VCO) in communication with the first active low pass loop filter. The first active low pass loop filter conditions a signal sent from the photodiode to the VCO. The VCO outputs a signal with a frequency that corresponds to the specific wavelengths of signals outputted by the tunable laser.

The PLL circuit may further include a programmable frequency divider in communication with the VCO, a frequency/phase comparator in communication with the programmable frequency divider, a frequency reference in communication with the comparator, and a second active low pass filter in communication with the comparator and the tunable optical filter. The divider has a variable frequency divider ratio that determines the output frequency of the VCO and the specific wavelengths of the signals outputted by the tunable laser. The frequency/phase comparator detects differences between signals outputted by the programmable frequency divider and signals outputted by the frequency reference source, and sends an error signal to the tunable optical filter via the second active low pass filter.

The wavelength discriminating filter may be a dielectric layered filter deposited directly on an active region of the photodiode, a fiber Bragg grating type filter, or a Fabry-Perot filter.

In an alternate embodiment, an optical frequency synthesizer controls an optical gain medium to output signals having specific wavelengths. The synthesizer includes a wavelength discriminating device, a wavelength tuning device in communication with the optical gain medium, and a phase locked loop (PLL) circuit in communication with the wavelength discriminating device and the wavelength tuning device. The wavelength discriminating device receives a sample of the signals outputted by the optical gain medium, processes the sample signals, and outputs the processed sample signals. Based on the processed sample signals received from the wavelength discriminating device, the PLL circuit controls the wavelength tuning device to alter the optical properties of the optical gain medium to output the signals having specific wavelengths.

The wavelength discriminating device may be a filter. The wavelength discriminating device may be incorporated into a tunable laser.

### BRIEF DESCRIPTION OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is a schematic of a conventional phase locked loop frequency synthesizer;

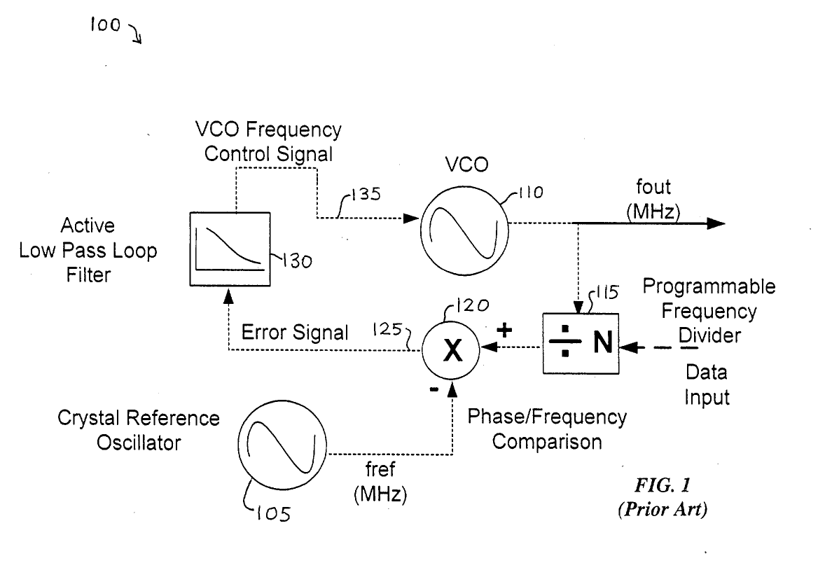

FIG. 2 is a schematic of a conventional phase locked loop frequency synthesizer used for response analysis;

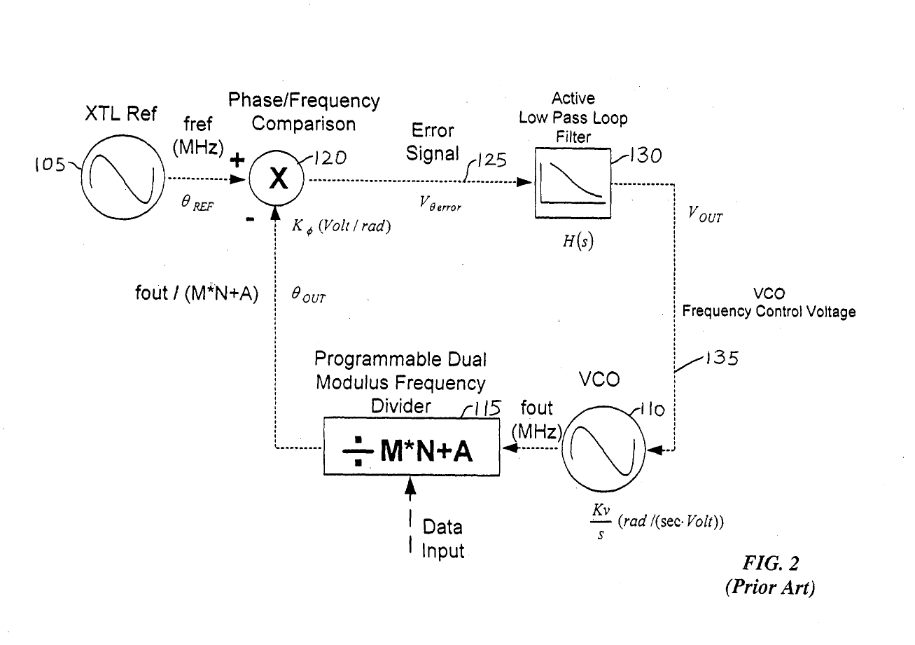

FIG. 3 is a schematic diagram of a phase locked loop (PLL) circuit that controls a tunable laser in accordance with one embodiment of the present invention;

FIG. 4 is a schematic diagram of a phase locked loop (PLL) circuit that controls an optical gain medium of a tunable laser in accordance with the present invention;

FIG. 5 shows the elements that include the terms used to determine the loop response of the PLL circuit of FIGS. 3 and 4;

FIG. 6 is a graph of the frequency output of a voltage controlled oscillator used to control a tunable laser versus the output wavelength of the tunable laser in accordance with one embodiment of the present invention;

FIG. 7 is a graphical presentation of closed loop responses circuit in accordance with one embodiment of the present invention; and

FIG. 8 is a table of parameter values used by the PLL circuit in accordance with one embodiment of the present invention.

### DETAILED DESCRIPTION OF THE INVENTION

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

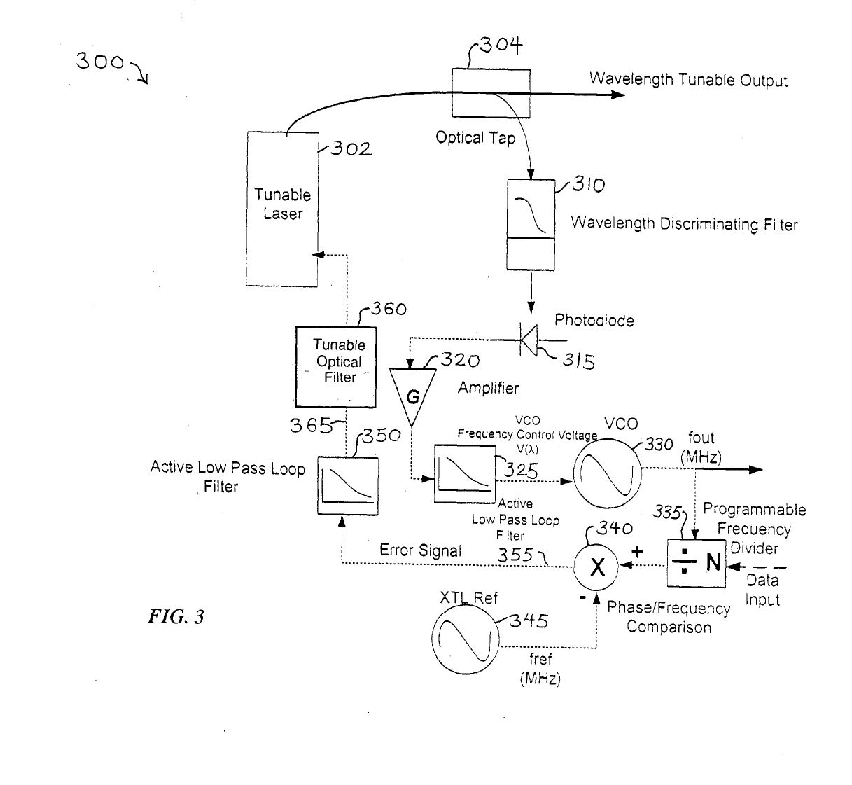

FIG. 3 shows a schematic of an optical frequency synthesizer including a phase locked loop (PLL) circuit 300 in communication with a tunable laser 302 and a directional coupler 304, operating in accordance with one embodiment of the present invention. The PLL circuit 300 is used to control and stabilize the output signal wavelength of tunable laser 302. The PLL circuit 300 controls the tunable laser 302 in a way characteristic of a voltage-to-wavelength converter having units of nm/V in loop calculations.

A portion of the output of the tunable laser 302 is tapped off via directional coupler 304 and is used to close the feedback loop by converting this optical signal back to an electrical quantity whose value corresponds in a one-to-one fashion to the wavelength being emitted by the tunable laser 302. An optical receiver circuit consisting of a photodiode 315 and an RF amplifier 320 accomplishes the optical-to-electrical conversion process. Before the optical-to-electrical conversion takes place, the one-to-one correspondence between the value of the detected electrical signal and the wavelength outputted by tunable laser 302 must be established through any number of means, depending on the exact physical design and behavior of the tunable laser 302. The relationship might be intrinsic to the tunable laser 302 itself if, for example, the output power of the tunable laser 302 changes in direct correspondence to the wavelength being emitted. In this case, the photo detector 315 is connected directly to the tapped optical signal output of directional coupler 304. If the output power of the tunable laser 302 remains constant as the device is tuned, then a wavelength discriminating filter 310 having a monotonic single valued transmission response, in the optical band of interest, is placed in the path between the tapped optical signal from directional coupler 304 and the photodiode 315, in order to establish the wavelength versus received voltage relationship based on a sample of the output of the tunable laser 302. The passbands of the wavelength discriminating filter 310 have some finite bandwidth, and each longitudinal optical mode may exist anywhere within one of the individual passbands of the wavelength discriminating filter 310. The wavelength discriminating filter 310 may be a fiber Bragg grating type filter, a Fabry-Perot filter, or a dielectric layered filter deposited directly on the active region of the photodiode 315. Other types of wavelength discrimination filters are within the scope of the present invention.

The PLL 300 compares a very stable frequency produced by a crystal frequency reference source 345 to frequencies outputted by a variable voltage controlled oscillator (VCO) 330 as determined by the voltage produced by the output of the RF amplifier 320 as a result of the output of photodiode 315. An active low pass loop filter 325 is placed at the output of the RF amplifier 320 that follows the photodiode 315. Before a phase/frequency comparison can take place, the frequency outputted by the VCO 330 must first be divided by a programmable frequency divider 335. An N division factor of the frequency divider 335 is used to compare the output of the crystal frequency reference source 345 to the output of the VCO 330. A phase/frequency comparator 340 produces an error signal 355 that has a magnitude and a polarity which are commensurate with the phase/frequency error that has been sensed. The error signal 355 is conditioned and scaled by an active low pass loop filter 350 so that it is suitable for controlling the tunable laser 302 after being routed through the tunable optical filter 360 or any other mechanism used to control the tunable laser 302.

This advancement comes about by first recognizing that the VCO 330 is single valued, whereby there is a one-to-one correspondence between the control voltage applied to the VCO 330 and its output frequency. Since the VCO 330 control voltage is related to the wavelength of the tunable laser 302 with a one-to-one correspondence, a direct one-to-one relationship between the output frequency of the VCO 330 and the output wavelength (optical frequency) of the tunable laser 302 is provided by the present invention. Hence, if the frequency divider ratio of the programmable frequency divider 335 is changed so as to tune the VCO 330 to another frequency, the tunable laser 302 responds by retuning to the corresponding wavelength. When the PLL 300 locks the VCO 330 onto the correct frequency, the tunable laser 302 is also be locked onto the corresponding wavelength.

In order to realize the functionality of the optical frequency synthesizer, the control voltage 365 at the output of the active low pass filter 350 is routed to the tunable optical filter 360 that, in this case, acts as the wavelength tuning mechanism for the tunable laser 302. The active low pass filter 350, itself, may have to be modified in order to ensure that its output signal is compatible with the tunable optical filter 360. For example, the bandwidth, transmission response roll off, signal level, and polarity of the active low pass filter 350 may need to be adjusted. The control voltage (loop error signal) of the PLL circuit 300 controls the wavelength of the tunable laser 302, rather than the frequency of the VCO 330 directly. Thus, the loop error signal 355 is now represented in the form of an optical signal rather than an electrical signal.

Depending on the particular mathematical relationship between the wavelength-to-electrical conversion, it may be determined that the function of the active low pass filter 350 has been lost or severely distorted. The wavelength discriminating filter 310 has a dB vs. wavelength response that may corrupt the response of the active low pass filter 350 connected to the output of the phase/frequency comparator 340 of the PLL circuit 300. Thus, typically, the electrical output signal of the photodiode 315 requires the active low pass filter 325 in order to condition the signal so that it can control the frequency of the VCO 330 with minimal noise. The output of the active low filter 325 can be connected to the control terminals of the VCO 330 to close the feedback loop of the PLL circuit 300 and tune and lock both the RF frequency of VCO 330 and the wavelength of the tunable laser 302 simultaneously. Changing the frequency divider ratio N of programmable frequency divider 335 then forces the error signal outputted by the phase/frequency divider 335 to be nonzero, causing the wavelength of the laser 302 to tune, which, in turn, initiates the tuning of the frequency of the VCO 330 until the error is once again restored to zero at the new optical wavelength and RF frequency.

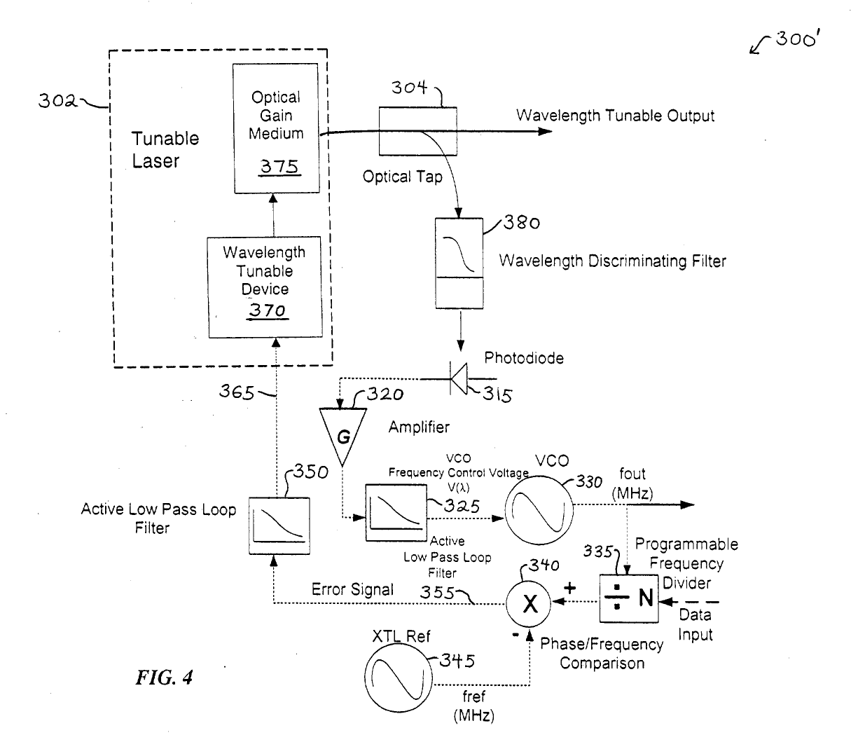

FIG. 4 shows a schematic of an optical frequency synthesizer including PLL circuit 300 in communication with a tunable laser 302 and a directional coupler 304. In an alternate embodiment, the tunable laser 302 includes a wavelength tuning device 370 and an optical gain medium 375 to output signals having specific wavelengths. The synthesizer includes a wavelength discriminating device 380, a wavelength tuning device in communication with the optical gain medium 375, and a PLL circuit 300 in communication with the wavelength discriminating device 380 and the wavelength tuning device 370. The wavelength discriminating device 380 receives a sample of the signals outputted by the optical gain medium, processes the sample signals, and outputs the processed sample signals. Based on the processed sample signals received from the wavelength discriminating device 380, the PLL circuit 300 controls the wavelength tuning device 370 to alter the optical properties of the optical gain medium 375 to output the signals having specific wavelengths. The wavelength discriminating device 380 may be a filter. Alternatively, the functionality of wavelength discriminating device 380 may be incorporated into tunable laser 302.

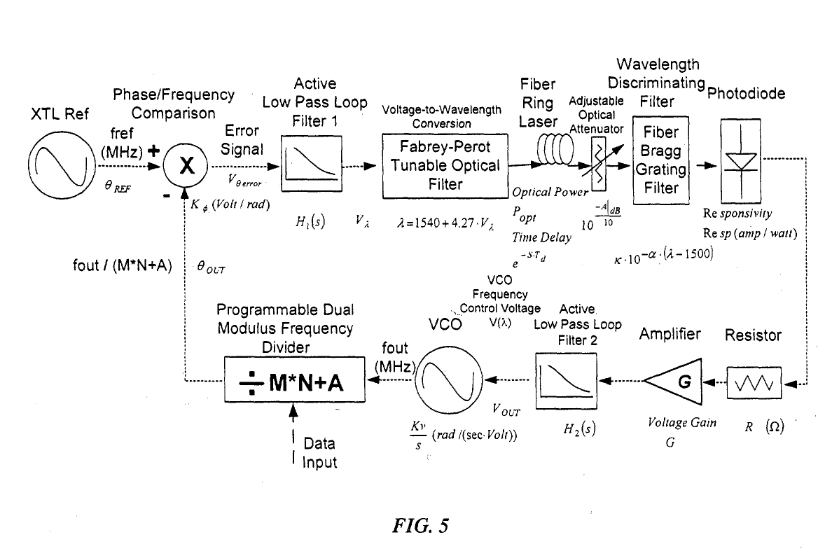

FIG. 5 shows response parameters used in Equations (2)-(17) to calculate the loop response of the present invention. This analysis is for the very specific case of an optical frequency synthesizer based upon a tunable erbium doped fiber ring laser, including a fiber Bragg grating wavelength discrimination filter. The loop response calculations for other optical frequency synthesizers which may incorporate different tunable laser technologies, different optical wavelength discrimination methods, or different component choices or values may necessarily differ from the analysis presented herein. However, the general methods remain constant. The mechanism for tuning the fiber ring laser is a voltage controlled tunable fiber Fabry-Perot optical filter. This laser is based upon a gain saturated erbium doped fiber amplifier design and it therefore emits a constant optical power Pₒₚₜ at all wavelengths within its specified gain band and tuning filter range. From the diagram of FIG. 5, the following equations can immediately be derived (noting that s=complex frequency variable):

$$\begin{matrix}{V}_{OUT} = {P}_{OPT} \cdot {10}^{- \frac{A}{10}} \cdot κ \cdot {10}^{- α ( λ - 1500 )} \cdot {ⅇ}^{- s \cdot {T}_{D}} \cdot {R}_{esp} \cdot R \cdot G \cdot {H}_{2} ( s ) & ( 2 ) \\ {θ}_{OUT} = {V}_{OUT} \cdot \frac{{K}_{v}}{s} \cdot \frac{1}{M \cdot N + A} & ( 3 )\end{matrix}$$

Vₑᵣᵣₒᵣ=K_{φ}·(θ_{REF}−θ_{OUT}) (4)

The tuning response of the tunable optical filter is depicted as:

λ=1540+4.27·(Vₑᵣᵣₒᵣ·H₁(s)) (5)

Plug (4) into (5):

λ=1540+4.27·K_{φ}·H₁(s)·(θ_{REF}−θ_{OUT}) (6)

Plug (2) into (3):

$$\begin{matrix}{θ}_{OUT} = \frac{{K}_{v}}{s} \cdot \frac{1}{M \cdot N + A} \cdot {P}_{OPT} \cdot \\ {10}^{- \frac{A}{10}} \cdot κ \cdot {10}^{- α ( λ - 1500 )} \cdot {ⅇ}^{- s \cdot {T}_{D}} \cdot {R}_{esp} \cdot R \cdot G \cdot {H}_{2} ( s ) & ( 7 ) \\ Plug ( 6 ) into ( 7 ) : \\ {θ}_{OUT} = \frac{{K}_{v}}{s} \cdot \frac{1}{M \cdot N + A} \cdot {P}_{OPT} \cdot {10}^{- \frac{A}{10}} \cdot \\ κ \cdot {10}^{- α \cdot \{ ( ( 1540 + 4.27 \cdot {K}_{φ} \cdot {H}_{1} ( s ) \cdot ( {θ}_{REF} - {θ}_{OUT} ) ) - 1500 ) \}} \cdot \\ {ⅇ}^{- s \cdot {T}_{D}} \cdot {R}_{esp} \cdot R \cdot G \cdot {H}_{2} ( s ) & ( 8 )\end{matrix}$$

Rewrite (8) by collecting all of the constant terms:

$${θ}_{OUT} = \frac{{ⅇ}^{- s \cdot {T}_{D}}}{s} \cdot \frac{{K}_{v}}{M \cdot N + A} \cdot {R}_{esp} \cdot R \cdot G \cdot {P}_{OPT} \cdot {10}^{- \frac{A}{10}} \cdot \\ κ \cdot {10}^{- α \cdot 40} \cdot {10}^{- α \cdot 4.27 \cdot {K}_{φ} \cdot {H}_{1} ( s ) \cdot ( {θ}_{REF} - {θ}_{OUT} )} \cdot {H}_{2} ( s ) \qquad ( 9 )$$

Define Γ as:

$$Γ = {K}_{v} \cdot {R}_{esp} \cdot R \cdot G \cdot {P}_{OPT} \cdot {10}^{- \frac{A}{10}} \cdot κ \cdot {10}^{- α \cdot 40} \qquad ( 10 )$$

Using Formula (10), Formula (9) is rewritten as:

$${θ}_{OUT} = \\ \frac{{ⅇ}^{- s \cdot {T}_{D}}}{s} \cdot \frac{Γ}{M \cdot N + A} \cdot {10}^{- α \cdot 4.27 \cdot {K}_{φ} \cdot {H}_{1} ( s ) ( {θ}_{REF} - {θ}_{OUT} )} \cdot {H}_{2} ( s ) \qquad ( 11 )$$

Use the conversion 10^{-α·X}=e^{-α·X·ln(10)} to rewrite 11 as:

$${θ}_{OUT} = \\ \frac{{ⅇ}^{- s \cdot {T}_{D}}}{s} \cdot \frac{Γ}{M \cdot N + A} \cdot {ⅇ}^{- α \cdot 4.27 \cdot ln ( 10 ) \cdot {K}_{φ} \cdot {H}_{1} ( s ) \cdot ( {θ}_{REF} - {θ}_{OUT} )} \cdot {H}_{2} ( s ) \qquad ( 12 )$$

Define γ as:

γ=α·4.27·ln(10)·K_{φ} (13)

Using Formula (10), Formula (12) is rewritten as:

$${θ}_{OUT} = \frac{{ⅇ}^{- s \cdot {T}_{D}}}{s} \cdot \frac{Γ}{M \cdot N + A} \cdot {ⅇ}^{- γ \cdot {H}_{1} ( s ) \cdot ( {θ}_{REF} - {θ}_{OUT} )} \cdot {H}_{2} ( s ) \qquad ( 14 )$$

In order to find the transfer function relating θ_{OUT} to θ_{REF} use the following:

θₑᵣᵣₒᵣ=θ_{REF}−θ_{OUT} (15)

Then:

$$\frac{{θ}_{OUT}}{{θ}_{REF}} = \frac{{θ}_{OUT}}{{θ}_{error} + {θ}_{OUT}} \qquad ( 16 )$$

Using (14), (15), and (16) the transfer function can be written as:

$$\frac{{θ}_{OUT}}{{θ}_{REF}} = \frac{\frac{{ⅇ}^{- s \cdot {T}_{D}}}{s} \cdot \frac{Γ}{M \cdot N + A} \cdot {ⅇ}^{- γ \cdot {H}_{1} ( s ) \cdot ( {θ}_{error} )} \cdot {H}_{2} ( s )}{{θ}_{error} + \frac{{ⅇ}^{- s \cdot {T}_{D}}}{s} \cdot \frac{Γ}{M \cdot N + A} \cdot {ⅇ}^{- γ \cdot {H}_{1} ( s ) \cdot ( {θ}_{error} )} \cdot {H}_{2} ( s )} \qquad ( 17 )$$

Unlike in conventional PLL circuits, such as the one described using Equation (1), a second low pass filter, H₂(s), is inserted into the optical frequency synthesizer control loop. In Equation (16), the first low pass filter response, H₁(s), which precedes the electrical-to-optical conversion ultimately ends up appearing in the exponent of e as a direct consequence of the optical transmission behavior of the fiber Bragg grating filter utilized as the wavelength discrimination device. Once exponentiated, the characteristic of H₁(s) is completely distorted from its original low pass filter response and, in fact, it can even take on a compressed high pass filter characteristic behavior. In order to overcome this distorted response, a second low pass filter, H₂(s), must be included in the optical frequency synthesizer control loop after the optical-to-electrical conversion, otherwise frequency locking is impossible.

Another important difference between the response of the conventional PLL circuit described using Equation (1), and the present invention described using Equation (17) is the appearance of the time delay factor, e^{-s·T}^{_{D}}, due to the propagation time of the optical wave through the optical devices, and, in the case of the tunable optical filter, the delay time due to the piezo-mechanical tuning mechanism. This delay can cause resonant peaking and instability in the optical frequency synthesizer transfer function. However, with the appropriate design of H₂(s) the peaking can be squelched and the loop stability restored.

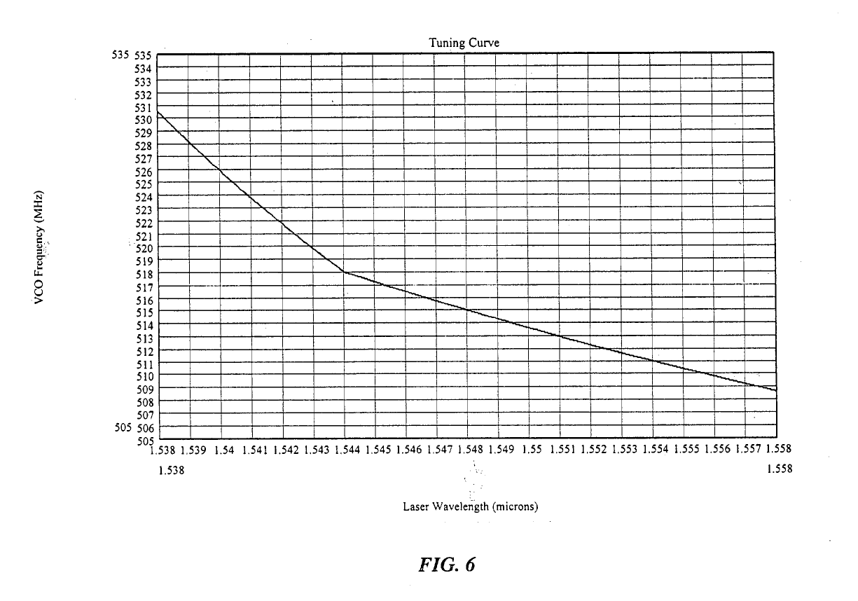

FIG. 6 shows a typical tuning curve for an Optical Frequency Synthesizer based upon a tunable erbium doped fiber ring laser.

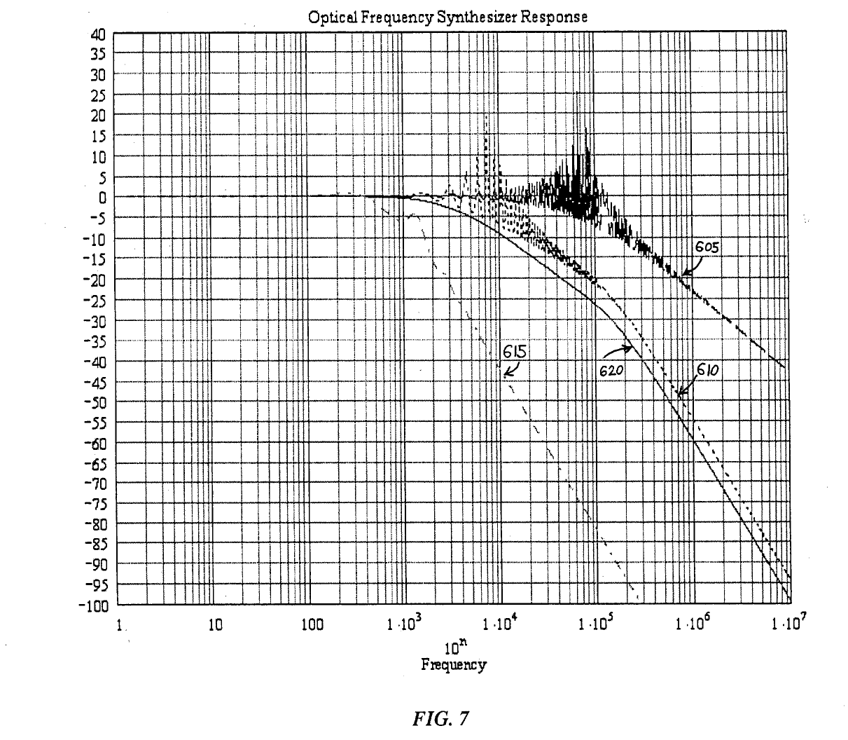

FIG. 7 shows three different closed loop responses for an example of the present invention, each with a different H₂(s) low pass filter function. This embodiment of the present invention is based upon an erbium doped fiber ring laser utilizing a piezo-mechanically tunable fiber Fabry-Perot filter. The estimated loop delay time is 0.7 ms. The rightmost curve 605 shows the loop response with H₂(s)=1, with no second low pass filter present. The next loop response curve 610 is for H₂(s)=H₁(s), without optimizing H₂(s), and the H₁(s) low pass function is simply recreated at the output of the loop's optical receiver circuit. The leftmost curve 615 shows the modified optical frequency synthesizer loop response when H₂(s) is redesigned to squelch the resonance peaking due to the optical wave's time and tuning delays. Finally, the curve 620 which is second from the left shows the original loop response of the basic RF PLL circuit with H₁(s) as the loop filter without any of the optical components present.

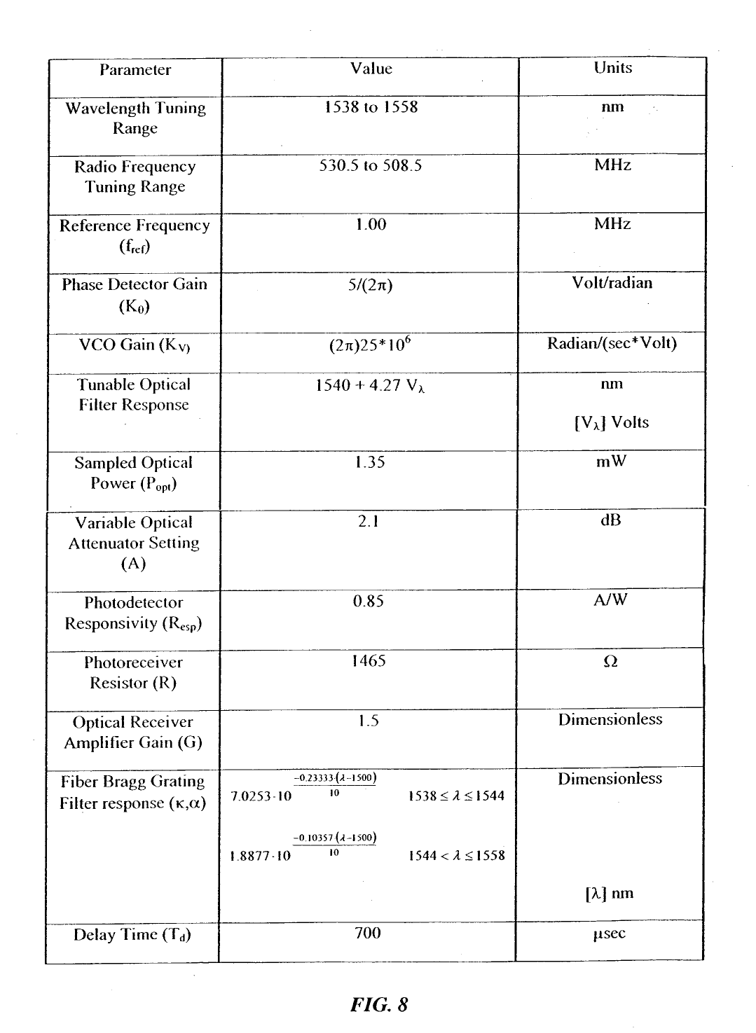

FIG. 8 is a table of parameter values used by the PLL circuit in accordance with one embodiment of the present invention.

The VCO can tune to a new radio frequency at a much faster rate than the laser is able to tune to a new optical frequency. This is because the VCO is tuned by applying the frequency control voltage to a varactor diode in the oscillator's circuitry while the laser is tuned by applying the wavelength control voltage to a piezo-mechanically adjustable filter. The varactor diode is purely electronic and does not involve any mechanically movement of components while the optical filter requires the physical movement of its internal components. The mechanical adjusting of the optical filter is a much slower process than the electronic setting of the varactor diode's capacitance. Because of the vast discrepancy in the tuning times, it has been found that with these particular tuning mechanisms, it is difficult to absolutely lock both the laser and VCO simultaneously. If the voltage controlled RF oscillator is steadfastly locked to the reference frequency, then it is quite difficult to persistently lock the laser onto a wavelength. In this situation, the wavelength of the tunable laser slowly fluctuates about the desired tuning wavelength, but never remains locked on one wavelength for any useful duration. Furthermore, the more tightly locked the VCO is to the reference, the wider the window is in which the wavelength fluctuates. This, naturally, is true up to a limit beyond which both the VCO and the tunable laser each become unlocked. However, in the current situation, it is not the VCO locking which is of prime importance, but rather the tunable laser precisely locking onto a chosen wavelength. In order to accomplish this, it has been found that the VCO's frequency must instead be allowed to fluctuate about the radio frequency corresponding to the desired optical wavelength to be locked (as in FIGS. 3 and 4). In order to allow for some controlled “dithering” of the output frequency of the VCO, the locking bandwidth of the control loop of the VCO is intentionally broadened by partially bypassing the input to the second low pass filter H₂(s) with a capacitor. This essentially allows for a very controlled amount of noise to be injected onto the control voltage lines of the VCO. The result is that the VCO dithers about its lock-in frequency, and the window about which it dithers is determined by the amount of noise which is introduced by the capacitor bypassing of the second low pass filter. As the dithering window is increased, up to a limit, the optical wavelength becomes more tightly locked to the corresponding wavelength. Once the radio frequency dithering window limit is exceeded, the optical wavelength again begins to waver and eventually the locking is totally lost.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. An optical frequency synthesizer which controls a tunable laser to output signals having specific wavelengths, the synthesizer comprising:
(a) a wavelength discriminating filter that receives a sample of the signals outputted by the tunable laser, filters the sample signals, and outputs the filtered sample signals;
(b) a tunable optical filter in communication with the laser; and
(c) a phase locked loop (PLL) circuit in communication with the wavelength discriminating filter and the tunable optical filter, wherein, based on the filtered sample signals received from the wavelength discriminating filter, the PLL circuit controls the tunable optical filter to tune the laser to output the signals having specific wavelengths.

2. The synthesizer of claim 1 wherein the PLL circuit comprises:
(d) a photodiode in communication with the wavelength discriminating filter; and
(e) an amplifier in communication with the photodiode, wherein the photodiode and amplifier are used to convert the filtered sample signals into electrical signals.

3. The synthesizer of claim 2 wherein the PLL circuit further comprises:
(f) a first active low pass loop filter in communication with the amplifier; and
(g) a voltage controlled oscillator (VCO) in communication with the first active low pass loop filter, wherein the first active low pass loop filter conditions a signal sent from the photodiode to the VCO, and the VCO outputs a signal with a frequency that corresponds to the specific wavelengths of signals outputted by the tunable laser.

4. The synthesizer of claim 3 wherein the PLL circuit further comprises:
(h) a programmable frequency divider in communication with the VCO, the divider having a variable frequency divider ratio that determines the output frequency of the VCO and the specific wavelengths of the signals outputted by the tunable laser;
(i) a frequency/phase comparator in communication with the programmable frequency divider;
(j) a frequency reference source in communication with the comparator; and
(k) a second active low pass filter in communication with the comparator and the tunable optical filter, wherein the frequency/phase comparator detects differences between signals outputted by the programmable frequency divider and signals outputted by the frequency reference source, and sends an error signal to the tunable optical filter via the second active low pass filter.

5. The synthesizer of claim 2 wherein the wavelength discriminating filter is a dielectric layered filter deposited directly on an active region of the photodiode.

6. The synthesizer of claim 1 wherein the wavelength discriminating filter is a fiber Bragg grating type filter.

7. The synthesizer of claim 1 wherein the wavelength discriminating filter is a Fabry-Perot filter.

8. An optical frequency synthesizer which controls an optical gain medium to output signals having specific wavelengths, the synthesizer comprising:
(a) a wavelength discriminating device that receives a sample of the signals outputted by the optical gain medium, processes the sample signals, and outputs the processed sample signals;
(b) a wavelength tuning device in communication with the optical gain medium; and
(c) a phase locked loop (PLL) circuit in communication with the wavelength discriminating device and the wavelength tuning device, wherein, based on the processed sample signals received from the wavelength discriminating device, the PLL circuit controls the wavelength tuning device to alter the optical properties of the optical gain medium to output the signals having specific wavelengths.

9. The synthesizer of claim 8 wherein the PLL circuit comprises:
(d) a photodiode in communication with the wavelength discriminating device; and
(e) an amplifier in communication with the photodiode, wherein the photodiode and amplifier are used to convert the processed sample signals into electrical signals.

10. The synthesizer of claim 9 wherein the PLL circuit further comprises:
(f) a first active low pass loop filter in communication with the amplifier; and
(g) a voltage controlled oscillator (VCO) in communication with the first active low pass loop filter, wherein the first active low pass loop filter conditions a signal sent from the photodiode to the VCO, and the VCO outputs a signal with a frequency that corresponds to the specific wavelengths of signals outputted by the optical gain medium.

11. The synthesizer of claim 10 wherein the PLL circuit further comprises:
(h) a programmable frequency divider in communication with the VCO, the divider having a variable frequency divider ratio that determines the output frequency of the VCO and the specific wavelengths of the signals outputted by the optical gain medium;
(i) a frequency/phase comparator in communication with the programmable frequency divider;
(j) a frequency reference source in communication with the comparator; and
(k) a second active low pass filter in communication with the comparator and the wavelength tuning device, wherein the frequency/phase comparator detects differences between signals outputted by the programmable frequency divider and signals outputted by the frequency reference source, and sends an error signal to the wavelength tuning device via the second active low pass filter.

12. The synthesizer of claim 8 wherein the wavelength discriminating device is a filter.

13. The synthesizer of claim 8 further wherein the wavelength tuning device and the optical gain medium are comprised by a tunable laser.
